(19) United States
(12) Patent Application Publication
(10) Pub. No.: US 2025/0329726 A1
(43) Pub. Date: Oct. 23, 2025

(54) AQUEOUS BATTERY

(71) Applicant: TOYOTA JIDOSHA KABUSHIKI KAISHA, Toyota-shi (JP)

(72) Inventors: Hiroshi SUYAMA, Mishima-shi (JP); Shigeki SATO, Fujinomiya-shi (JP); Ryushin YAMANAKA, Susono-shi (JP); Hiroko KUWATA, Sunto-gun (JP)

(73) Assignee: TOYOTA JIDOSHA KABUSHIKI KAISHA, Toyota-shi (JP)

(21) Appl. No.: 19/052,663

(22) Filed: Feb. 13, 2025

(30) Foreign Application Priority Data
Mar. 1, 2024 (JP) 2024-031464
Dec. 18, 2024 (JP) 2024-221932

(51) Int. Cl. H01M 4/525; H01M 4/505; H01M 4/66; H01M 10/26

(52) U.S. Cl. CPC H01M 4/525; H01M 4/505; H01M 4/661; H01M 10/26; H01M 2300/0008

(57) ABSTRACT

Disclosed is a novel active material operatable in an aqueous battery. The aqueous battery of the present disclosure includes a positive electrode, an aqueous electrolyte solution and a negative electrode. The positive electrode includes a positive electrode active material, and the negative electrode includes a negative electrode active material. One of or both the positive electrode active material and the negative electrode active material include(s) a composite oxide. The composite oxide contains Na, at least one transition metal element of Fe, Ti, Ni and Mn, and O. The aqueous electrolyte solution contains water and potassium polyphosphate dissolved in the water.

### FIELD

The present application discloses an aqueous battery.

### BACKGROUND

PTL 1 discloses an aqueous electrolyte solution for aqueous batteries, which includes water and potassium pyrophosphate dissolved at a concentration of 2 mol or more per 1 kg of the water. When an aqueous battery is formed with the aqueous electrolyte solution disclosed in PTL 1, a potential window on the reduction side of the aqueous electrolyte solution is wide, and thus the aqueous electrolyte solution is easily inhibited from being decomposed on an electrode surface even when an aqueous battery is charged and discharged.

### CITATION LIST

### Patent Literature

[PTL 1] Japanese Unexamined Patent Publication No. 2019-220294

### SUMMARY

### Technical Problem

There is a demand for a novel material usable as an active material with Na (sodium) which is a resource relatively abundantly present, in an aqueous battery with an aqueous electrolyte solution with potassium polyphosphate.

### Solution to Problem

The present application discloses, as the aforementioned solution to problem, a plurality of aspects below.

### <Aspect 1>

An aqueous battery comprising a positive electrode, an aqueous electrolyte solution, and a negative electrode, wherein
the positive electrode comprises a positive electrode active material,
the negative electrode comprises a negative electrode active material,
   one of or both the positive electrode active material and the negative electrode active material comprise(s) a composite oxide,
      the composite oxide comprises
         Na,
         at least one transition metal element of Fe, Ti, Ni and Mn, and O, and
the aqueous electrolyte solution comprises
   water and
   potassium polyphosphate dissolved in the water.

### <Aspect 2>

The aqueous battery according to aspect 1, wherein
one of or both the positive electrode active material and the negative electrode active material comprise(s) at least one of a first composite oxide, a second composite oxide, and a third composite oxide,
   the first composite oxide has a composition represented by NaₓFe_{1-y}M¹_{y}O₂,
   the second composite oxide has a composition represented by NaₓTi_{1-y}M²_{y}O₂,
   the third composite oxide has a composition represented by NaₓNi_{1-y}M³_{y}O₂,
   wherein
      0<x≤1 is satisfied,
      0≤y≤1 is satisfied,
      M comprises one of or both Ti and Mn and does not comprise Ni,
      M² comprises one of or both Fe and Mn and does not comprise Ni, and
      M³ comprises at least one of Fe, Ti and Mn.

### <Aspect 3>

The aqueous battery according to aspect 2, wherein
the negative electrode active material comprises one of or both the first composite oxide and the second composite oxide.

### <Aspect 4>

The aqueous battery according to aspect 3, wherein
M¹ corresponds to one of or both Ti and Mn, and
M² corresponds to one of or both Fe and Mn.

### <Aspect 5>

The aqueous battery according to any one of aspects 2 to 4, wherein
the positive electrode active material comprises the third composite oxide.

### <Aspect 6>

The aqueous battery according to aspect 5, wherein
M³ is at least one of Fe, Ti and Mn.

### <Aspect 7>

The aqueous battery according to any one of aspects 1 to 6, wherein
the aqueous electrolyte solution comprises the potassium polyphosphate dissolved at a concentration of 3 mol or more per 1 kg of the water.

### <Aspect 8>

The aqueous battery according to any one of aspects 1 to 7, wherein
the aqueous electrolyte solution comprises the potassium polyphosphate dissolved at a concentration of 3 mol or more and 6 mol or less per 1 kg of the water.

### <Aspect 9>

The aqueous battery according to any one of aspects 1 to 8, wherein
the aqueous electrolyte solution comprises the potassium polyphosphate dissolved at a concentration of 4 mol or more and 6 mol or less per 1 kg of the water.

### <Aspect 10>

The aqueous battery according to any one of aspects 1 to 9, wherein
the aqueous electrolyte solution has no freezing point at −40° C. or higher.

### <Aspect 11>

The aqueous battery according to any one of aspects 1 to 10, wherein
the aqueous electrolyte solution does not involve salt precipitation when cooled from 0° C. to −40° C.

### <Aspect 12>

The aqueous battery according to any one of aspects 1 to 11, wherein
the aqueous electrolyte solution has a viscosity of 10 mPa·s or more and 600 mPa·s or less at 20° C.

### <Aspect 13>

The aqueous battery according to any one of aspects 1 to 12, wherein
a pH of the aqueous electrolyte solution is 3 or more and 13 or less.

### <Aspect 14>

The aqueous battery according to any one of aspects 1 to 13, wherein
one of or both the positive electrode and the negative electrode comprise(s) a current collector comprising Al.

### <Aspect 15>

The aqueous battery according to aspect 14, wherein
the aqueous battery has a bipolar structure,
a positive electrode active material layer is formed on one side of the current collector, and
a negative electrode active material layer is formed on the other side of the current collector.

### Effects

The aqueous battery of the present disclosure can be charged and discharged by combining a predetermined active material and a predetermined aqueous electrolyte solution.

### BRIEF DESCRIPTION OF DRAWINGS

FIG. 1 schematically shows an example of a structure of an aqueous battery.

FIG. 2 schematically shows an example of a structure of an aqueous battery.

FIG. 3 shows a charge-discharge curve of Example 1.

FIG. 4 shows a charge-discharge curve of Example 2.

FIG. 5 shows a charge-discharge curve of Example 3.

FIG. 6 shows a charge-discharge curve of Example 4.

FIG. 7 shows a charge-discharge curve of Example 5.

FIG. 8 shows a charge-discharge curve of Example 6.

FIG. 9 shows a charge-discharge curve of Example 7.

FIG. 10 shows a charge-discharge curve of Example 8.

FIG. 11 shows a charge-discharge curve of Example 9.

FIG. 12 shows a charge-discharge curve of Example 10.

FIG. 13 shows a charge-discharge curve of Example 11.

FIG. 14 shows a charge-discharge curve of Example 12.

FIG. 15 shows a charge-discharge curve of Example 13.

FIG. 16 shows a charge-discharge curve of Example 14.

FIG. 17 shows a charge-discharge curve of Example 15.

FIG. 18 shows a charge-discharge curve of Example 16.

FIG. 19 shows a charge-discharge curve of Example 17.

### DESCRIPTION OF EMBODIMENTS

One embodiment of the aqueous battery of the present disclosure will be described below with reference to the drawings, but the technology of the present disclosure is not limited to the following embodiments.

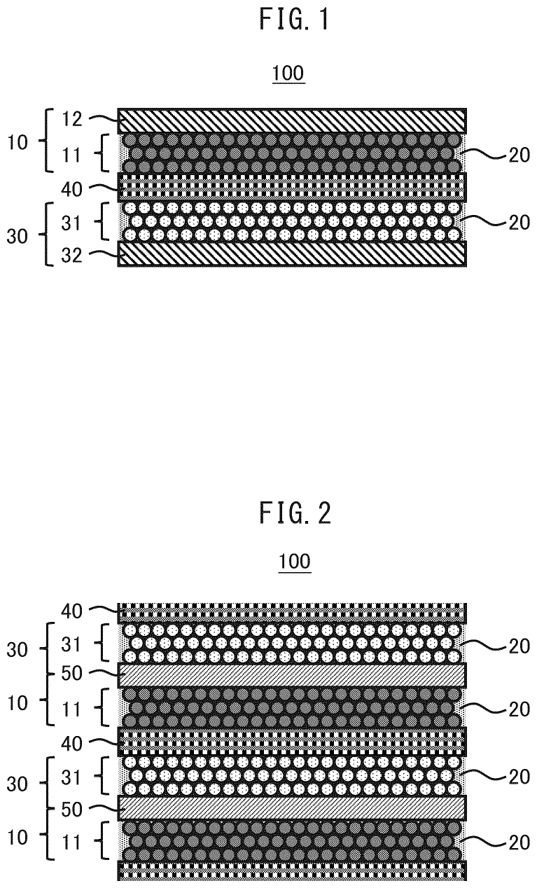

As shown in FIG. 1, an aqueous battery 100 according to one embodiment includes a positive electrode 10, an aqueous electrolyte solution 20, and a negative electrode 30. The positive electrode 10 includes a positive electrode active material. The negative electrode 30 includes a negative electrode active material. One of or both the positive electrode active material and the negative electrode active material include(s) a composite oxide. The composite oxide contains Na, at least one transition metal element of Fe, Ti, Ni and Mn, and O. The aqueous electrolyte solution 20 contains water and potassium polyphosphate dissolved in the water.

### 1. Active Material

An aqueous battery 100 according to one embodiment includes a predetermined composite oxide as an active material. According to the inventors' new findings, the charge-discharge potential (potential at which carrier ions are absorbed and released) of the composite oxide is varied depending on the type and amount of the transition metal element contained in the composite oxide. Specifically, as the proportions of Fe and Ti in the transition metal element contained in the composite oxide are higher, the charge-discharge potential tends to be lower. As the proportion of Ni in the transition metal element contained in the composite oxide is higher, the charge-discharge potential tends to be higher. In other words, the composite oxide can function as the positive electrode active material or the negative electrode active material depending on the composition. The positive electrode active material and the negative electrode active material can be appropriately selected in consideration of the potential window or the like of the aqueous electrolyte solution 20.

### 1.1 Composition

An aqueous battery 100 according to one embodiment may include one of or both the following structures (1) and (2).
(1) The positive electrode 10 includes a composite oxide containing Na, one of or both transition metal elements of Fe and Ti, and O, as a positive electrode active material. The composite oxide as the positive electrode active material may contain Mn. The composite oxide as the positive electrode active material does not optionally contain Ni.
(2) The negative electrode 30 includes a composite oxide containing Na, Ni, and O, as a negative electrode active material. The composite oxide as the negative electrode active material may contain at least one of Fe, Ti and Mn.

In an aqueous battery 100 according to one embodiment, one of or both the positive electrode active material and the negative electrode active material may include at least one of a first composite oxide, a second composite oxide and a third composite oxide. The first composite oxide has a composition represented by NaₓFe_{1-y}M¹_{y}O₂. The second composite oxide has a composition represented by NaₓTi_{1-y}M²_{y}O₂. The third composite oxide has a composition represented by NaₓNi_{1-y}M³_{y}O₂. Herein, 0<x≤1 is satisfied, 0≤y≤1 is satisfied, M¹ contains one of or both Ti and Mn and does not contain Ni, M² contains one of or both Fe and Mn and does not contain Ni, and M³ contains at least one of Fe, Ti and Mn.

In the composition, x is more than 0 and 1 or less. x may be 0.1 or more, 0.2 or more, 0.3 or more, 0.4 or more, 0.5 or more, 0.6 or more, or 0.7 or more. In one embodiment, x may be 0.5 or more and 1.0 or less, or 0.7 or more and 1.0 or less. In the composition, y is 0 or more and 1 or less. y may be more than 0, 0.1 or more, 0.2 or more, 0.3 or more, or 0.4 or more, and may be less than 1, 0.9 or less, 0.8 or less, 0.7 or less, 0.6 or less, 0.5 or less or 0.4. In one embodiment, y may be 0 or more and 0.5 or less, or 0 or more and 0.4 or less.

As described above, as the proportions of Fe and Ti in the transition metal element contained in the composite oxide are higher, the charge-discharge potential tends to be lower, and in this case, the composite oxide is suitable as the negative electrode active material. In this regard, in an aqueous battery 100 according to one embodiment. The negative electrode active material may contain one of or both the first composite oxide and the second composite oxide. For example, the first composite oxide and/or the second composite oxide do/does not optionally contain any element other than Fe, Ti and Mn in the transition metal element. Specifically, M¹ may correspond to one of or both Ti and Mn. M² may correspond to one of or both Fe and Mn. In this case, the composite oxide can be constituted by a relatively inexpensive element.

As described above, as the proportion of Ni in the transition metal element contained in the composite oxide is higher, the charge-discharge potential tends to be higher, and in this case, the composite oxide is suitable as the positive electrode active material. In this regard, in an aqueous battery 100 according to one embodiment, the positive electrode active material may contain the third composite oxide. For example, the third composite oxide does not optionally contain any element other than Ni, Fe, Ti and Mn in the transition metal element. Specifically, M³ may be at least one of Fe, Ti and Mn. In this case, the composite oxide can be constituted by a relatively inexpensive element.

### 1.2 Crystal Structure

The composite oxide may have, for example, a layered structure (for example, at least one selected from an O3-type structure, an O2-type structure and a P2-type structure), a spinel-type structure, or a tunnel structure such as hollandite, romanechite, ramsdellite, nsutite, or pyrolusite. The composite oxide may have a plurality of kinds of crystal phases.

### 1.3 Shape

The shapes of the positive electrode active material and the negative electrode active material may be any shapes capable of functioning as the active materials of the aqueous battery. The positive electrode active material and the negative electrode active material may be, for example, in the form of particles. The positive electrode active material and the negative electrode active material may be solid particles, hollow particles, particles with voids, or porous particles. The positive electrode active material and the negative electrode active material may be each a primary particle, or a secondary particle obtained by agglomeration of a plurality of primary particles. The average particle diameters D50 of the positive electrode active material and the negative electrode active material may be each, for example, 1 nm or more, 5 nm or more, or 10 nm or more, and may be 500 μm or less, 100 μm or less, 50 μm or less, or 30 μm or less. The mean particle diameter D50 in the present application is the particle diameter (median diameter) at 50% of the integrated value in the volume-based particle diameter distribution determined by the laser diffraction and scattering method.

### 1.4 Other Items

As described above, in an aqueous battery 100 according to one embodiment, one of or both the positive electrode active material and the negative electrode active material can contain the composite oxide. For example, in one embodiment, the positive electrode active material contains the composite oxide and the negative electrode active material contains any composite oxide other than the above composite oxide adopted as the positive electrode active material. Alternatively, in one embodiment, the positive electrode active material contains the composite oxide and the negative electrode active material does not contain the composite oxide. Alternatively, in one embodiment, the positive electrode active material does not contain the composite oxide and the negative electrode active material contains the composite oxide. Only one positive electrode active material may be used alone, or two or more thereof may be used in combination. Only one negative electrode active material may be used alone, or two or more thereof may be used in combination.

Any known active material for aqueous batteries may be adopted as the active material other than the above composite oxide. Such any positive electrode active material other than the composite oxide (any other positive electrode active material) can be appropriately selected in consideration of the potential window or the like of the aqueous electrolyte solution 20. Such any other positive electrode active material may be, for example, a compound known as a positive electrode active material for aqueous proton batteries (for example, transition metal oxide) or a compound known as a positive electrode active material for aqueous potassium ion batteries (for example, an organic active material such as Prussian blue). Such any negative electrode active material other than the composite oxide (any other negative electrode active material) is one having a charge-discharge potential lower than that of the positive electrode active material, and can be appropriately selected in consideration of the potential window or the like of the aqueous electrolyte solution 20. Such any other negative electrode active material may be, for example, potassium-transition metal composite oxide; titanium oxide; metal sulfides such as Mo₆S₈; elemental sulfur; KTi₂(PO₄)₃; NASICON-type compounds, and the like. Such any other positive electrode active material and such any other negative electrode active material may be each one which inserts and deinserts carrier ions by intercalation, or which inserts and deinserts carrier ions by a conversion reaction or an alloying reaction.

### 2. Aqueous Electrolyte Solution

The aqueous electrolyte solution 20 in the aqueous battery 100 contains water and potassium polyphosphate dissolved in the water. The composite oxide as the positive electrode active material and/or the negative electrode active material can insert and deinsert carrier ions in the aqueous electrolyte solution at a predetermined potential. The carrier ions correspond to various ions contained in the aqueous electrolyte solution 20. In one embodiment, the carrier ions may be protons. Namely, the aqueous battery 100 may be an aqueous proton battery. Alternatively, in one embodiment, the carrier ions may be potassium ions. Namely, the aqueous battery 100 may be an aqueous potassium ion battery. Alternatively, in one embodiment, the carrier ions may be hydroxide ions or polyphosphate ions. Namely, the aqueous battery 100 may be an aqueous anion battery.

As described above, the aqueous electrolyte solution 20 contains water and potassium polyphosphate dissolved in the water. An aqueous electrolyte solution 20 according to one embodiment may contain water, potassium ions, and polyphosphate ions. Such an aqueous electrolyte solution 20 may contain any component other than water and potassium polyphosphate. For example, such an aqueous electrolyte solution 20 may contain K₃₋ₓHₓPO₄ (1≤x) or polyphosphate dissolved in the water. Such an aqueous electrolyte solution 20 can be held between the positive electrode 10 and the negative electrode 30 by a separator 40 and thus be brought into contact with the positive electrode 10 and the negative electrode 30.

### 2.1 Solvent

The aqueous electrolyte solution 20 contains water as a solvent. The solvent contains water as a main component. Namely, water accounts for 50 mol % or more and 100 mol % or less of the total amount of solvent constituting the aqueous electrolyte solution (100 mol %). Water may account for 70 mol % or more, 90 mol % or more, or 95 mol % or more of the total amount of the solvent. Meanwhile, the upper limit of the proportion of water in the solvent is not particularly limited. The solvent may be composed only of water (100 mol % water).

The solvent may contain, in addition to water, for example, solvents other than water, for example, from the viewpoint of forming solid electrolyte interphase (SEI) on the surface of the active material. Examples of solvents other than water include one or more organic solvents selected from ethers, carbonates, nitriles, alcohols, ketones, amines, amides, sulfur compounds and hydrocarbons. The solvents other than water may account for 50 mol % or less, 30 mol % or less, 10 mol % or less, or 5 mol % or less of the total amount of solvents constituting the electrolyte solution (100 mol %).

### 2.2 Electrolyte

An electrolyte is dissolved in the aqueous electrolyte solution 20, and the electrolyte in the aqueous electrolyte solution 20 may dissociate into cations and anions. In the aqueous electrolyte solution 20, the cations and the anions may form aggregates (associations) in close proximity to each other.

### 2.2.1 Potassium Polyphosphate

The aqueous electrolyte solution 20 contains potassium polyphosphate dissolved in the water. The “potassium polyphosphate” refers to a salt in which at least some of hydrogen atoms in polyphosphate are substituted with potassium atoms. Namely, the “potassium polyphosphate” encompasses potassium hydrogen polyphosphate in concept. Specific examples of the potassium polyphosphate include potassium pyrophosphate (K₄₋ₓHₓP₂O₇) and potassium tripolyphosphate (K₅₋ₓHₓP₃O₁₀). In particular, when potassium pyrophosphate (K₄₋ₓHₓP₂O₇) is adopted as the potassium polyphosphate, much higher performance is easily ensured. The “potassium polyphosphate dissolved in water” in the aqueous electrolyte solution 20 may be present as potassium ions, polyphosphate ions or aggregates (associations) of these ions, or aggregates (associations) with potassium hydrogen phosphate-, phosphate- or polyphosphate-derived ions described below. In the aqueous electrolyte solution 20, ions, aggregates (associations), and the like contained in the aqueous electrolyte solution 20 can be converted into the potassium polyphosphate, thereby specifying “concentration of potassium polyphosphate dissolved in water”. Herein, the “potassium polyphosphate dissolved in water” in the present application may be one in which a cation source (for example, potassium compound) and an anion source (for example, polyphosphate) are separately added to the aqueous electrolyte solution 20, resulting in formation of the ions or aggregates (associations) thereof in the aqueous electrolyte solution 20.

The concentration of the potassium polyphosphate in the aqueous electrolyte solution 20 is not particularly limited. According to the inventors' new findings, when the aqueous electrolyte solution 20 includes the potassium polyphosphate dissolved at a concentration of 3 mol or more per 1 kg of the water, particularly, includes the potassium polyphosphate dissolved at a concentration of 3 mol or more and 6 mol or less per 1 kg of the water, further particularly, includes the potassium polyphosphate dissolved at a concentration of 4 mol or more and 6 mol or less per 1 kg of the water, the effect of enhancing other characteristics such as electrochemical stability of the electrolyte solution can be expected. When the concentration of the potassium polyphosphate in the aqueous electrolyte solution 20 is such a concentration, an aqueous electrolyte solution 20 having no freezing point at −60° C. or higher is easily obtained.

### 2.2.2 Cation

The aqueous electrolyte solution 20 can contain protons or potassium ions as cations. In the aqueous electrolyte solution 20, some of potassium ions contained in the aqueous electrolyte solution 20 can be converted as “potassium polyphosphate dissolved”. Here, the aqueous electrolyte solution 20 may contain more potassium ions than the concentration which can be converted as the potassium polyphosphate. For example, when not only the potassium polyphosphate, but also a potassium ion source (for example, KOH, CH₃COOK, K₃PO₄, KH₂PO₄, K₂HPO₄, K₅P₃O₁₀, K₆P₄O₁₃, or K₇P₅O₁₆, (KPO₃)n) other than the potassium polyphosphate is added to and dissolved in water during production of the aqueous electrolyte solution 20, more potassium ions than the concentration which can be converted as the potassium polyphosphate are contained in the aqueous electrolyte solution 20. Other cations may be contained in the aqueous electrolyte solution 20 as long as the above problems can be solved. For example, alkali metal ions other than potassium ions, alkaline earth metal ions, transition metal ions, and the like may be contained.

### 2.2.3 Anion

The aqueous electrolyte solution 20 can contain hydroxide ions or polyphosphate ions (which may be present in a state of being linked to cations as mentioned above) as anions. The aqueous electrolyte solution 20 can contain other anions as long as the above problems can be solved. For example, anions derived from other electrolytes described below may be contained.

### 2.2.4 Other Components which can be Included in Aqueous Electrolyte Solution

The aqueous electrolyte solution 20 may contain other electrolytes. For example, the aqueous electrolyte solution 20 may contain at least one of the potassium hydrogen phosphate, phosphate, and polyphosphate dissolved in the water. The “potassium hydrogen phosphate” may be one of or both potassium monohydrogen phosphate (K₂HPO₄) and potassium dihydrogen phosphate (KH₂PO₄). In the aqueous electrolyte solution 20, the “potassium hydrogen phosphate dissolved in water” and the “phosphate dissolved in water” may be present as ions such as K⁺, H⁺, PO₄³⁻, KPO₄²⁻, HPO₄²⁻, K₂PO₄⁻, H₂PO₄⁻, or KHPO₄⁻, aggregates (associations) of these ions, or the above-mentioned aggregates (associations) with potassium polyphosphate-derived ions, and the “polyphosphate dissolved in water” may be present as H⁺, polyphosphate anions, or the above-mentioned aggregates (associations) with potassium polyphosphate-derived ions. In the aqueous electrolyte solution 20, ions, aggregates (associations), and the like contained in the aqueous electrolyte solution 20 can be converted into potassium hydrogen phosphate, phosphate, or polyphosphate, thereby specifying “concentration of potassium hydrogen phosphate dissolved in water”, “concentration of phosphate dissolved in water”, or “concentration of polyphosphate dissolved in water”. Herein, the “potassium hydrogen phosphate dissolved in water” in the present application may be one in which a cation source (for example, potassium compound) and an anion source (for example, polyphosphate) are separately added to the aqueous electrolyte solution 20, resulting in formation of ions such as K⁺, H⁺, PO₄³⁻, KPO₄²⁻, HPO₄²⁻, K₂PO₄⁻, H₂PO₄⁻, or KHPO₄⁻, or aggregates (associations) of these ions in the aqueous electrolyte solution 20.

The aqueous electrolyte solution 20 may contain an electrolyte other than the phosphate compound. For example, the aqueous electrolyte solution 20 may contain at least one selected from KPF₆, KBF₄, K₂SO₄, KNO₃, CH₃COOK, (CF₃SO₂)₂NK, KCF₃SO₃, (FSO₂)₂NK, K₂HPO₄, KH₂PO₄, KPO₃, K₅P₃O₁₀, K₆P₄O₁₃, K₇P₅O₁₆, (KPO₃)n, and the like.

The electrolyte other than the potassium polyphosphate may account for 50 mol % or less, 30 mol % or less, or 10 mol % or less of the total amount of the electrolyte (100 mol %) dissolved in the electrolyte solution.

The aqueous electrolyte solution 20 may contain, in addition to the electrolyte, various additives.

### 2.3 Other Properties

As long as the aqueous electrolyte solution 20 includes the solvent and the electrolyte, other properties are not particularly limited. Hereinafter, an example of such other properties of the aqueous electrolyte solution 20 will be described.

### 2.3.1 Freezing Point

The aqueous electrolyte solution 20 may have no freezing point at −40° C. or higher. Here, the presence or absence of “freezing point” of the aqueous electrolyte solution 20 is confirmed by differential scanning calorimetry (DSC). Note that the DSC sweep rate is set at 5° C./min for both descending temperature and ascending temperature, and the sweep range is set as follows: temperature descending to −120° C. from room temperature, followed by temperature ascending to 40° C. The atmosphere in DSC is an atmosphere of inert gas such as Ar, and the pressure is equal to the atmospheric pressure. However, since a sealed aluminum container is used for the evaluation, the atmosphere inside the container is the sealed atmosphere under atmospheric pressure. If the crystallization peak temperature (freezing point temperature) is not confirmed at −40° C. or higher in measurement of the aqueous electrolyte solution under the above conditions, the aqueous electrolyte solution is considered to have “no freezing point at −40° C. or higher”. The aqueous electrolyte solution 20 may have no freezing point at −60° C. or higher, no freezing point at −80° C. or higher, no freezing point at −100° C. or higher, or no freezing point at −120° C. or higher. In order to achieve the conditions that “aqueous electrolyte solution 20 has no freezing point at −40° C. or higher” in the aqueous battery 100 of the present disclosure, it is effective to allow the concentration of the potassium polyphosphate in the aqueous electrolyte solution 20 to be a high concentration. The aqueous electrolyte solution 20 has no freezing point at −40° C. and thus elution of a current collector into the aqueous electrolyte solution 20 is easily suppressed. The aqueous electrolyte solution 20 has no freezing point at −40° C., and thus the aqueous battery 100 can be used even at extremely low temperature. Namely, the aqueous battery 100 can be appropriately operated even in cold district.

### 2.3.2 Presence or Absence of Salt Precipitation

The aqueous electrolyte solution 20 may involve no salt precipitation when cooled from 0° C. to −40° C. The aqueous electrolyte solution 20 involves no salt precipitation due to temperature change, thereby making stable ionic conduction possible even at low temperature. For example, the aqueous battery 100 can be used even at extremely low temperature in cold district. The aqueous electrolyte solution 20 may include water and potassium polyphosphate dissolved in the water, as mentioned above. According to the inventors' findings, the saturation solubility of potassium polyphosphate in water has low temperature dependence and scarcely changes at low temperature of 0° C. or lower. In this regard, even if the aqueous electrolyte solution 20 is cooled from 0° C. to −40° C., salt precipitation hardly occurs in the aqueous electrolyte solution 20.

### 2.3.3 Viscosity

If the viscosity of the aqueous electrolyte solution 20 is too high, the ionic conductivity of the aqueous electrolyte solution 20 may deteriorate. Meanwhile, if potassium polyphosphate is dissolved at high concentration in the aqueous electrolyte solution 20, the aqueous electrolyte solution 20 may have a certain level or more of the viscosity. From the foregoing viewpoints, the aqueous electrolyte solution 20 may have a viscosity of 10 mPa·s or more and 600 mPa·s or less at 20° C. The viscosity may be 500 mPa·s or less, 400 mPa·s or less, 350 mPa·s or less, or 300 mPa·s or less.

### 2.3.4 pH

The pH of the aqueous electrolyte solution 20 is not particularly limited. However, if the pH is too high, the potential window on the oxidation side of the aqueous electrolyte solution may be narrow. In this regard, the pH of the aqueous electrolyte solution 20 may be 3 or more and 13 or less. Alternatively, the pH may be 3 or more, 4 or more, 5 or more, 6 or more, or 7 or more, and may be 14 or less, 13.5 or less, 13 or less, 12.5 or less, 12 or less, 11 or less, 10 or less, or 9 or less. In particular, if the pH of the aqueous electrolyte solution 20 is 3 or more and 13 or less, 4 or more and 12.5 or less, 4 or more and 12 or less, 4 or more and 11.5 or less, 4 or more and 11 or less, or 5 or more and 13 or less, among these, 5 or more and 10 or less, more excellent performance is easily ensured.

### 3. Other Structures

Hereinafter, an example of other structures included in the aqueous battery 100 will be described.

### 3.1 Positive Electrode

The positive electrode 10 includes the above-mentioned positive electrode active material. As shown in FIG. 1, the positive electrode 10 may include, for example, a positive electrode active material layer 11 and a positive electrode current collector 12. In this case, the positive electrode active material layer 11 includes the positive electrode active material.

### 3.1.1 Positive Electrode Active Material Layer

The positive electrode active material layer 11 is impregnated with the aqueous electrolyte solution 20. The positive electrode active material layer 11 may contain, in addition to the positive electrode active material, a conductive aid, a binder, and/or the like. The positive electrode active material layer 11 may contain other various additives. The content of each component in the positive electrode active material layer 11 may be appropriately determined according to the objective battery performance. For example, the content of the positive electrode active material may be 40% by mass or more, 50% by mass or more, 60% by mass or more, or 70% by mass or more, and may be 100% by mass or less, or 90% by mass or less, based on 100% by mass of the entire positive electrode active material layer 11 (total solid content). The shape of the positive electrode active material layer 11 is not particularly limited, and the positive electrode active material layer may be, for example, a sheet-shaped positive electrode active material layer having an approximately flat surface. The thickness of the positive electrode active material layer 11 is not particularly limited, and may be, for example, 0.1 μm or more, 1 μm or more, or 10 μm or more, and may be 2 mm or less, 1 mm or less, or 500 μm or less.

Examples of the conductive aid which can be included in the positive electrode active material layer 11 include carbon materials such as vapor-phase-grown carbon fiber (VGCF), acetylene black (AB), Ketjen black (KB), carbon nanotube (CNT) and carbon nanofiber (CNF); and metal materials such as nickel, titanium, aluminum, stainless steel and the like which are slightly insoluble (poorly soluble) in an aqueous electrolyte solution. The conductive aid may be, for example, in the form of particles or fibers, and the size thereof is not particularly limited. Only one conductive aid may be used alone, or two or more thereof may be used in combination.

Examples of the binder which can be included in the positive electrode active material layer 11 include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, polyimide (PI)-based binders, carboxymethylcellulose (CMC)-based binders and the like. Only one binder may be used alone, or two or more thereof may be used in combination.

### 3.1.2 Positive Electrode Current Collector

As shown in FIG. 1, the positive electrode 10 may include a positive electrode current collector 12 in contact with the positive electrode active material layer 11. The positive electrode current collector 12 is in contact with the aqueous electrolyte solution 20. It is possible to use, as the positive electrode current collector 12, any material capable of functioning as the positive electrode current collector of the aqueous battery. The positive electrode current collector 12 may be in the form of foil, plate, mesh, perforated metal and foam. The positive electrode current collector 12 may be formed of a metal foil or a metal mesh. In particular, the metal foil is excellent in ease of handling or the like. The positive electrode current collector 12 may be composed of a plurality of foils. Examples of the metal material constituting the positive electrode current collector 12 include those containing at least one selected from the group consisting of Cu, Ni, Al, V, Au, Pt, Mg, Fe, Ti, Pb, Co, Cr, Zn, Ge, In, Sn, and Zr. The positive electrode current collector 12 may be one in which the above metal is plated or vapor-deposited on a metal foil or a base material. In particular, the positive electrode current collector 12 preferably contains Al. When the positive electrode current collector 12 contains Al, the positive electrode current collector 12 may be entirely composed of Al or at least one portion of a surface thereof may be composed of Al. For example, the positive electrode current collector 12 may be composed of an Al foil, or may be one in which a surface of a metal foil or any base material is covered with Al. The positive electrode current collector 12 may be one in which Al is present on at least one portion of a surface in contact with the aqueous electrolyte solution 20, or may be one in which Al is present on the entire of a surface in contact with the aqueous electrolyte solution 20. When the positive electrode current collector 12 is composed of a plurality of metal foils, any layer may be included between the plurality of metal foils. The thickness of the positive electrode current collector 12 is not particularly limited. For example, the thickness may be 0.1 μm or more, or 1 μm or more, and may be 1 mm or less, or 100 μm or less.

### 3.2 Negative Electrode

The negative electrode 30 includes the above-mentioned negative electrode active material. As shown in FIG. 1, the negative electrode 30 may include, for example, a negative electrode active material layer 31 and a negative electrode current collector 32. In this case, the negative electrode active material layer 31 includes the negative electrode active material.

### 3.2.1 Negative Electrode Active Material Layer

The negative electrode active material layer 31 is impregnated with the aqueous electrolyte solution 20. The negative electrode active material layer 31 may contain, in addition to the negative electrode active material, a conductive aid, a binder, and/or the like. The negative electrode active material layer 31 may contain other various additives. The content of each component in the negative electrode active material layer 31 may be appropriately determined according to the objective battery performance. For example, the content of the negative electrode active material may be 40% by mass or more, 50% by mass or more, 60% by mass or more, or 70% by mass or more, and may be 100% by mass or less, or 90% by mass or less, based on 100% by mass of the entire negative electrode active material layer 31 (total solid content). The shape of the negative electrode active material layer 31 is not particularly limited, and the negative electrode active material layer may be, for example, a sheet-shaped negative electrode active material layer having an approximately flat surface. The thickness of the negative electrode active material layer 31 is not particularly limited, and may be, for example, 0.1 μm or more, 1 μm or more, or 10 μm or more, and may be 2 mm or less, 1 mm or less, or 500 μm or less.

Examples of the conductive aid which can be included in the negative electrode active material layer 31 include carbon materials such as vapor-phase-grown carbon fiber (VGCF), acetylene black (AB), Ketjen black (KB), carbon nanotube (CNT) and carbon nanofiber (CNF); and metal materials such as nickel, titanium, aluminum, stainless steel and the like which are slightly insoluble (poorly soluble) in an aqueous electrolyte solution. The conductive aid may be, for example, in the form of particles or fibers, and the size thereof is not particularly limited. Only one conductive aid may be used alone, or two or more thereof may be used in combination.

Examples of the binder which can be included in the negative electrode active material layer 31 include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, polyimide (PI)-based binders, carboxymethylcellulose (CMC)-based binders and the like. Only one binder may be used alone, or two or more thereof may be used in combination.

### 3.2.2 Negative Electrode Current Collector

As shown in FIG. 1, the negative electrode 30 may include a negative electrode current collector 32 in contact with the negative electrode active material layer 31. The negative electrode current collector 32 is in contact with the aqueous electrolyte solution 20. It is possible to use, as the negative electrode current collector 32, any material capable of functioning as the negative electrode current collector of the aqueous battery. The negative electrode current collector 32 may be in the form of foil, plate, mesh, perforated metal, and foam. The negative electrode current collector 32 may be formed of a metal foil or a metal mesh. In particular, the metal foil is excellent in ease of handling or the like. The negative electrode current collector 32 may be composed of a plurality of foils. Examples of the metal material constituting the negative electrode current collector 32 include those containing at least one selected from the group consisting of Cu, Ni, Al, V, Au, Pt, Mg, Fe, Ti, Pb, Co, Cr, Zn, Ge, In, Sn, and Zr. In particular, the negative electrode current collector 32 preferably contains at least one selected from the group consisting of Al, Ti, Pb, Zn, Sn, Mg, Zr and In, particularly preferably contains Al. All of Al, Ti, Pb, Zn, Sn, Mg, Zr and In have low work function, and even if the negative electrode current collector 32 comes into contact with the aqueous electrolyte solution 20 on the reduction potential, it is considered to be difficult for the aqueous electrolyte solution 20 to undergo electrolysis. The negative electrode current collector 32 may be one in which the above metal is plated or vapor-deposited on a metal foil or a base material. When the negative electrode current collector 32 contains Al, the negative electrode current collector 32 may be entirely composed of Al or at least one portion of a surface thereof may be composed of Al. For example, the negative electrode current collector 32 may be composed of an Al foil, or may be one in which a surface of a metal foil or any base material is covered with Al. The negative electrode current collector 32 may be one in which Al is present on at least one portion of a surface in contact with the aqueous electrolyte solution 20, or may be one in which Al is present on the entire of a surface in contact with the aqueous electrolyte solution 20. When the negative electrode current collector 32 is composed of a plurality of metal foils, any layer may be included between the plurality of metal foils. The thickness of the negative electrode current collector 32 is not particularly limited. For example, the thickness may 0.1 μm or more, or 1 μm or more, and may be 1 mm or less, or 100 μm or less.

### 3.3 Separator

A separator 40 may be present between the positive electrode 10 and the negative electrode 30 in the aqueous battery 100. A separator used in conventional aqueous batteries (nickel hydrogen batteries, zinc air batteries, and the like) may be adopted as the separator 40. For example, a separator of anon-woven fabric or the like with cellulose as a material may be adopted. The thickness of the separator 40 is not particularly limited, and may be, for example, 5 μm or more and 1 mm or less.

### 3.4 Terminal and the Like

The aqueous battery 100 may include, in addition to the above structures, a terminal, a battery case, and/or the like. Other structures are obvious to those skilled in the art who refer to the present application, and therefore explanation will be omitted here.

### 4. Method for Producing Aqueous Battery

The aqueous battery 100 of the present disclosure can be produced, for example, as follows.

### 4.1 Method for Producing Aqueous Electrolyte Solution

The aqueous electrolyte solution 20 can be produced by, for example, mixing water and potassium polyphosphate. Alternatively, the aqueous electrolyte solution can be produced by mixing water, a potassium ion source, and a polyphosphate ion source. The mixing method is not particularly limited, and any known mixing method can be used. By simply filling a container with water, potassium polyphosphate, and any other optional component, followed by standing, they are mixed with each other to finally obtain an aqueous electrolyte solution 20.

### 4.2 Production of Positive Electrode

The positive electrode 10 is produced, for example, as follows. A positive electrode active material and etc. constituting the positive electrode active material layer 11 are dispersed in a solvent to obtain a positive electrode mixture paste (slurry). The solvent used in this case is not particularly limited, and water and various organic solvents can be used. Using a doctor blade or the like, the positive electrode mixture paste (slurry) is applied on the surface of the positive electrode current collector 12, and then dried to form a positive electrode active material layer 11 on the surface of the positive electrode current collector 12, thus obtaining a positive electrode 10. It is possible to use, as the coating method, an electrostatic coating method, a dip coating method, a spray coating method and the like, including a doctor blade method.

### 4.3 Production of Negative Electrode

The negative electrode 30 is produced, for example, as follows. A negative electrode active material and etc. constituting the negative electrode active material layer 31 are dispersed in a solvent to obtain a negative electrode mixture paste (slurry). The solvent used in this case is not particularly limited, and water and various organic solvents can be used. Using a doctor blade or the like, the negative electrode mixture paste (slurry) is applied on the surface of the negative electrode current collector 32, and then dried to form a negative electrode active material layer 31 on the surface of the negative electrode current collector 32, thus obtaining a negative electrode 30. It is possible to use, as the coating method, an electrostatic coating method, a dip coating method, a spray coating method and the like, including a doctor blade method.

### 4.4 Housing or the Like in Battery Case

The aqueous electrolyte solution 20, the positive electrode 10 and the negative electrode 30 are housed in a battery case to obtain an aqueous battery 100. For example, the separator 40 is sandwiched between the positive electrode 10 and the negative electrode 30 to obtain a laminate including the positive electrode current collector 12, the positive electrode active material layer 11, the separator 40, the negative electrode active material layer 31 and the negative electrode current collector 32 in this order. Other members such as terminal are attached to the laminate as necessary. The laminate is housed in a battery case and the battery case is filled with the aqueous electrolyte solution 20, and the laminate and the electrolyte solution are sealed in the battery case so that the laminate is immersed in the aqueous electrolyte solution 20 to obtain an aqueous battery 100.

### 5. Effect and the Like

The aqueous battery 100 of the present disclosure can be charged and discharged by combining a predetermined active material and a predetermined aqueous electrolyte solution. In the aqueous battery 100 of the present disclosure, an inorganic composite oxide is adopted as the active material. An inorganic active material is excellent in volume energy density or the like as compared with an organic active material.

In the aqueous battery 100 of the present disclosure, a predetermined aqueous electrolyte solution is adopted, and thus elution or the like of a current collector into the electrolyte solution is easily suppressed. For example, when one of or both the positive electrode 10 and the negative electrode 30 in the aqueous battery 100 has/have a current collector containing Al, elution of Al into the electrolyte solution can be suppressed. In a conventional aqueous battery, one containing Ti and Ni is adopted as a current collector, for measures against corrosion of the current collector (for example, PTL 1). Other metals than these are eluted, for example, at positive electrode potentials, and thus adoption thereof has been considered to be difficult. However, Ti and Ni are expensive, and therefore an alternate technology with a more inexpensive metal is needed in order to widely distribute an aqueous battery. In this regard, in the aqueous battery 100 of the present disclosure, not only one including Al is adopted as the current collector to reduce the cost of the entire battery, but also the aqueous electrolyte solution 20 is adopted to enable elution of Al from the current collector to the aqueous electrolyte solution to be suppressed.

The mechanism for suppression of elution of Al into the electrolyte solution in the case of inclusion of Al in the positive electrode current collector is as follows. First, the potential of the positive electrode is a potential on the oxidation side during charging and discharging of the battery. Therefore, Al included in the positive electrode current collector is in a state of releasing electrons and being easily dissolved. Specifically, Al included in the positive electrode current collector is not only coordinated with anions or water molecules included in the aqueous electrolyte solution, but also eluted into the aqueous electrolyte solution. Here, potassium polyphosphate is dissolved in the aqueous electrolyte solution 20 in the aqueous battery 100 of the present disclosure. In other words, anions derived from potassium polyphosphate, such as polyphosphate ions, may be present in the aqueous electrolyte solution 20. Therefore, in the aqueous battery 100 of the present disclosure, Al included in the positive electrode current collector 12 is easily coordinated with anions derived from potassium polyphosphate. For example, aluminum polyphosphate is extremely low in solubility in the aqueous electrolyte solution 20. Therefore, Al coordinated with anions derived from potassium polyphosphate is rapidly precipitated as a solid. In other words, an insoluble or slightly insoluble (poorly soluble) Al compound is precipitated near the surface of the positive electrode current collector 12, and the Al compound adheres to the surface of the positive electrode current collector 12 to form a protective film (passive film) on the surface. As a result, elution of Al from the positive electrode current collector 12 into the aqueous electrolyte solution 20 in the aqueous battery 100 of the present disclosure can be suppressed by the protective film.

The mechanism for suppression of elution of Al into the electrolyte solution in the case of inclusion of Al in the negative electrode current collector is as follows. First, the potential of the negative electrode is a potential on the reduction side during charging and discharging of the batter. Therefore, the aqueous electrolyte solution in contact with the negative electrode is electrolyzed to generate hydroxide ions, resulting in a tendency to increase the pH of the aqueous electrolyte solution near the negative electrode. If the pH of the aqueous electrolyte solution near the negative electrode is increased, the solubility of Al in the aqueous electrolyte solution is increased and Al included in the negative electrode current collector is easily eluted into the aqueous electrolyte solution. On the contrary, potassium polyphosphate is dissolved in the aqueous electrolyte solution 20 in the aqueous battery 100 of the present disclosure, as described above. Therefore, Al included in the negative electrode current collector 32 in the aqueous battery 100 of the present disclosure, even if eluted into the aqueous electrolyte solution 20 during charging and discharging of the battery, is rapidly coordinated with anions derived from potassium polyphosphate and is formed into an Al compound and precipitated as a solid. In other words, an insoluble or slightly insoluble (poorly soluble) Al compound is precipitated near the surface of the negative electrode current collector 32, and the Al compound adheres to the surface of the negative electrode current collector 32 to form a protective film (passive film) on the surface. As a result, elution of Al from the negative electrode current collector 32 into the aqueous electrolyte solution 20 in the aqueous battery 100 of the present disclosure can be suppressed by the protective film.

As described above, the same kinds of materials (for example, Al) may be adopted as the positive electrode current collector 12 and the negative electrode current collector 32 in the aqueous battery 100. In this regard, in the aqueous battery 100, a bipolar current collector which serves as both the positive electrode current collector 12 and the negative electrode current collector 32 may be adopted. Namely, the positive electrode 10 and the negative electrode 30 may share one current collector. FIG. 2 shows an example of a bipolar structure. As shown in FIG. 2, the aqueous battery 100 may have a bipolar structure, a positive electrode active material layer 11 may be formed on one side of a current collector 50 (bipolar current collector which functions as both the positive electrode current collector 12 and the negative electrode current collector 32) and a negative electrode active material layer 31 may be formed on the other side of the current collector 50. In this case, the current collector 50 may not have liquid permeability, that is, the aqueous electrolyte solution 20 may not permeate from the positive electrode active material layer 11 to the negative electrode active material layer 31 via the current collector 50 and vice versa.

### 6. Application of Aqueous Battery

The aqueous battery of the present disclosure can be suitably used, for example, in at least one vehicle selected from a hybrid electric vehicle (HEV), a plug-in hybrid electric vehicle (PHEV), and a battery electric vehicle (BEV). Namely, the technology of the present disclosure also has an aspect as a vehicle having an aqueous battery, wherein the aqueous battery includes a positive electrode, an aqueous electrolyte solution and a negative electrode, the positive electrode includes a positive electrode active material, the negative electrode includes a negative electrode active material, one of or both the positive electrode active material and the negative electrode active material include(s) a composite oxide, the composite oxide contains Na, at least one transition metal element of Fe, Ti, Ni and Mn, and O, and the aqueous electrolyte solution contains water and potassium polyphosphate dissolved in the water. The details of the positive electrode, the aqueous electrolyte solution and the negative electrode, and the details of the battery structures are as mentioned above.

### EXAMPLES

Hereinafter, the technology of the present disclosure will be described in more detail by way of Examples, but the technology of the present disclosure is not limited to the following Examples.

### 1. Fabrication of Aqueous Electrolyte Solution

Potassium pyrophosphate (K₄P₂O₇) was dissolved in pure water at a concentration of 5 mol/kg to obtain an aqueous electrolyte solution.

### 2. Fabrication of Active Material

A sodium source (sodium carbonate) and a transition metal source (a transition metal source or a composite salt including a plurality of kinds of transition metals) were mixed at a predetermined ratio, and fired to obtain each of active materials according to Examples 1 to 8.

### 2.1 Example 1: NaFeO₂

Na₂CO₃ and Fe₃O₄ were mixed at a molar ratio of Na:Fe=1:1, and fired at 700° C. for 12 hours under an air stream to obtain an active material according to Example 1.

### 2.2 Example 2: NaFe_{0.5}Ti_{0.5}O₂

Na₂CO₃, γFe₂O₃ and Ti₂O₃ were mixed at a molar ratio of Na:Fe:Ti=1:0.5:0.5, and fired at 700° C. for 12 hours under an argon stream to obtain an active material according to Example 2.

### 2.3 Example 3: NaFe_{0.5}Mn_{0.5}O₂

Na₂CO₃, γFe₂O₃ and Mn₂O₃ were mixed at a molar ratio of Na:Fe:Mn=1:0.5:0.5, and fired at 800° C. for 12 hours under an air stream to obtain an active material according to Example 3.

### 2.4 Example 4: Na_{0.7}Fe_{0.5}Mn_{0.5}O₂

Na₂CO₃, γFe₂O₃ and Mn₂O₃ were mixed at a molar ratio of Na:Fe:Mn=0.7:0.5:0.5, and fired at 800° C. for 12 hours under an air stream to obtain an active material according to Example 4.

### 2.5 Example 5: NaFe_{0.75}Ni_{0.25}O₂

Na₂CO₃, Fe₃O₄ and Ni₂O₃ were mixed at a molar ratio of Na:Fe:Ni=1:0.75:0.25, and fired at 700° C. for 12 hours under an air stream to obtain an active material according to Example 5.

### 2.6 Example 6: Na_{0.7}Mn_{0.6}Ni_{0.4}O₂, Example 7: Na_{0.5}Mn_{0.75}Ni_{0.25}O₂)

MnSO₄·5H₂O and NiSO₄·6H₂O were weighed at an objective compositional ratio, and dissolved in distilled water at a concentration of 1.2 mol/L to obtain a first solution. Na₂CO₃ was dissolved at a concentration of 1.2 mol/L in distilled water in another container to obtain a second solution. In a reaction container was placed 1000 mL of pure water, and 500 mL of the first solution and 500 mL of the second solution were each dropped thereinto at a rate of about 4 mL/min. After completion of dropping, these solutions were stirred at room temperature at a stirring rate of 150 rpm for 1 hour to obtain a product. The product was washed with pure water, and subjected to solid-liquid separation with a centrifuge to recover a precipitate. The precipitate obtained was dried at 120° C. overnight, ground in a mortar, and then separated into coarse particles and fine particles according to airflow classification, and the fine particles were removed to obtain precursor particles corresponding to a composite salt of Mn and Ni. The composite salt obtained and Na₂CO₃ were weighed at an objective compositional ratio, mixed, and then fired at 800° C. for 24 hours under an air stream to obtain each of active materials according to Examples 6 and 7.

### 2.7 Example 8: NaNi_{0.5}Ti_{0.5}O₂

Na₂CO₃, Ni₂O₃ and TiO₂ were mixed at a molar ratio of Na:Ni:Ti=1:0.5:0.5, and fired at 930° C. for 25 hours under an air stream to obtain an active material according to Example 8.

### 2.8 Example 9: NaFe_{0.5}Ni_{0.5}O₂

Na₂CO₃, γFe₂O₃ and Ni₂O₃ were mixed at a molar ratio of Na:Fe:Ni=1:0.5:0.5, and fired at 800° C. for 12 hours under an air stream to obtain an active material according to Example 9.

### 2.9 Example 10: Na_{0.7}Fe_{0.5}Ni_{0.5}O₂

Na₂CO₃, γFe₂O₃ and Ni₂O₃ were mixed at a molar ratio of Na:Fe:Ni=0.7:0.5:0.5, and fired at 800° C. for 12 hours under an air stream to obtain an active material according to Example 10.

### 2.10 Example 11: NaTi_{0.5}Mn_{0.5}O₂

Na₂CO₃, TiO₂ and Mn₂O₃ were mixed at a molar ratio of Na:Ti:Mn=1:0.5:0.5, and fired at 850° C. for 12 hours under an air stream to obtain an active material according to Example 11.

### 2.11 Example 12: Na_{0.7}Ti_{0.5}Mn_{0.5}O₂

Na₂CO₃, TiO₂ and Mn₂O₃ were mixed at a molar ratio of Na:Ti:Mn=0.7:0.5:0.5, and fired at 850° C. for 12 hours under an air stream to obtain an active material according to Example 12.

### 2.12 Example 13: NaFe_{0.75}Ti_{0.25}O₂

Na₂CO₃, γFe₂O₃ and TiO₂ were mixed at a molar ratio of Na:Ti:Mn=1:0.75:0.25, and fired at 850° C. for 12 hours under an argon stream to obtain an active material according to Example 13.

### 2.13 Example 14: NaNi_{0.5}Mn_{0.5}O₂

Na₂CO₃, Ni₂O₃ and Mn₂O₃ were mixed at a molar ratio of Na:Ni:Mn=1:0.5:0.5, and fired at 750° C. for 12 hours under an oxygen stream to obtain an active material according to Example 14.

### 2.14 Example 15: NaFe_{0.25}Ni_{0.75}O₂

Na₂CO₃, γFe₂O₃ and Ni₂O₃ were mixed at a molar ratio of Na:Fe:Ni=1:0.25:0.75, and fired at 750° C. for 12 hours under an oxygen stream to obtain an active material according to Example 15.

### 2.15 Example 16: NaTi_{0.25}Ni_{0.75}O₂

Na₂CO₃, TiO₂ and Ni₂O₃ were mixed at a molar ratio of Na:Ti:Ni=1:0.25:0.75, and fired at 750° C. for 12 hours under an oxygen stream to obtain an active material according to Example 16.

### 2.16 Example 17: NaMn_{0.25}Ni_{0.75}O₂

Na₂CO₃, Mn₂O₃ and Ni₂O₃ were mixed at a molar ratio of Na:Mn:Ni=1:0.25:0.75, and fired at 750° C. for 12 hours under an oxygen stream to obtain an active material according to Example 17.

The compositions of the respective active materials were as shown in Table 1 below. The crystal structures of the respective active materials were confirmed by X-ray diffraction patterns. The respective active materials included crystal structures shown in Table 1 below.

TABLE 1

| | Composition | Crystal structure |
|---|---|---|
| Example 1 | NaFeO₂ | Layered structure (O3-type structure) |
| Example 2 | NaFe_{0.5}Ti_{0.5}O₂ | Layered structure (O3-type structure) |
| Example 3 | NaFe_{0.5}Mn_{0.5}O₂ | Layered structure (O3-type structure) |
| Example 4 | Na_{0.7}Fe_{0.5}Mn_{0.5}O₂ | Layered structure (P2-type structure) |
| Example 5 | NaFe_{0.75}Ni_{0.25}O₂ | Layered structure (O3-type structure) |
| Example 6 | Na_{0.7}Mn_{0.6}Ni_{0.4}O₂ | Layered structure (P2-type structure) |
| Example 7 | Na_{0.5}Mn_{0.75}Ni_{0.25}O₂ | Layered structure (P2-type structure) |
| Example 8 | NaNi_{0.5}Ti_{0.5}O₂ | Layered structure (O3-type structure) |
| Example 9 | NaFe_{0.5}Ni_{0.5}O₂ | Layered structure (O3-type structure) |
| Example 10 | Na_{0.7}Fe_{0.5}Ni_{0.5}O₂ | Layered structure (P2-type structure) |
| Example 11 | NaTi_{0.5}Mn_{0.5}O₂ | Layered structure (O3-type structure) |
| Example 12 | Na_{0.7}Ti_{0.5}Mn_{0.5}O₂ | Layered structure (P2-type structure) |
| Example 13 | NaFe_{0.75}Ti_{0.25}O₂ | Layered structure (O3-type structure) |
| Example 14 | NaNi_{0.5}Mn_{0.5}O₂ | Layered structure (O3-type structure) |
| Example 15 | NaFe_{0.25}Ni_{0.75}O₂ | Layered structure (O3-type structure) |
| Example 16 | NaTi_{0.25}Ni_{0.75}O₂ | Layered structure (O3-type structure) |
| Example 17 | NaMn_{0.25}Ni_{0.75}O₂ | Layered structure (O3-type structure) |

### 3. Fabrication of Electrode

Each of the active materials, acetylene black (AB) as a conductive aid, styrene-butadiene rubber (SBR) and carboxymethyl cellulose (CMC) as binders, and water were mixed, and thereafter subjected to a defoaming treatment with a stirring/defoaming apparatus (Awatori Rentaro) at 2000 rpm for one minute to obtain an ink. The mass ratio among the active material, AB, SBR, and CMC included in the ink was 75:20:4:1. The ink was dripped on a metal foil secured on a glass plate, and applied with a doctor blade at a gap of 150 μm to form a coating film on the surface of the metal foil. The metal foil on which the coating film was formed was left to still stand under reduced pressure, and thereafter naturally dried and then further dried in a vacuum drier at 60° C. overnight to obtain an electrode having an active material layer on the surface of the metal foil. The electrode obtained was punched to a size of φ16 mm, and pressed at a linear pressure of 1 ton and thus densified to obtain an electrode for evaluation.

### 4. Electrochemical Measurement

### 4.1 Fabrication of Evaluation Cell

The electrode was used as a working electrode, a Ni foil was used as a counter electrode, Ag/AgCl was used as a reference electrode, and the aqueous electrolyte solution was used as an electrolyte solution to fabricate an electrochemical cell (VM4, manufactured by Interchemi Co., Ltd.).

### 4.2 Measurement Conditions

A charge-discharge test of each of the electrochemical cells was performed with an electrochemical measurement system, and whether or not charge and discharge were possible and the reaction potential were confirmed.

Electrochemical measurement system: VMP3 (manufactured by Bio-Logic Science Instruments)

Current value in evaluation: ±0.1 mA/cm²

Cut condition: −1.0 to 1.15 V vs. SHE

### 5. Results

### 5.1 Example 1: NaFeO₂

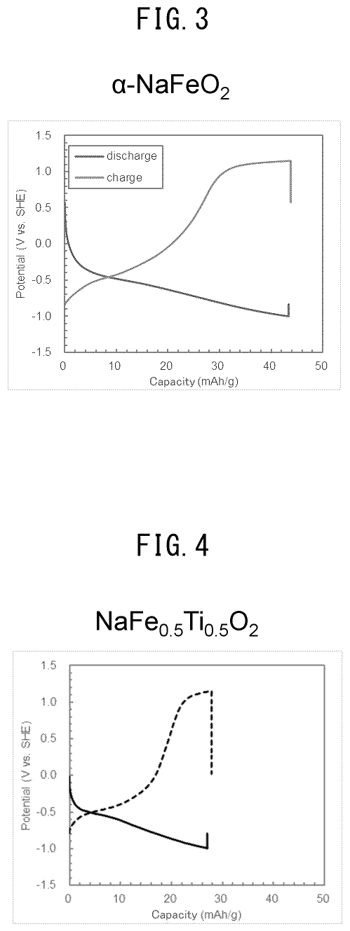

FIG. 3 shows a charge-discharge curve in the case of use of the active material according to Example 1. As shown in FIG. 3, charge and discharge in the aqueous electrolyte solution were possible with the active material according to Example 1. The reaction potential of the active material according to Example 1 was mainly a minus potential, and was found to be able to suitably function as, for example, the negative electrode active material.

### 5.2 Example 2: NaFe_{0.5}Ti_{0.5}O₂

FIG. 4 shows a charge-discharge curve in the case of use of the active material according to Example 2. As shown in FIG. 4, charge and discharge in the aqueous electrolyte solution were possible with the active material according to Example 2. The reaction potential of the active material according to Example 2 was mainly a minus potential, and was found to be able to suitably function as, for example, the negative electrode active material.

### 5.3 Example 3: NaFe_{0.5}Mn_{0.5}O₂

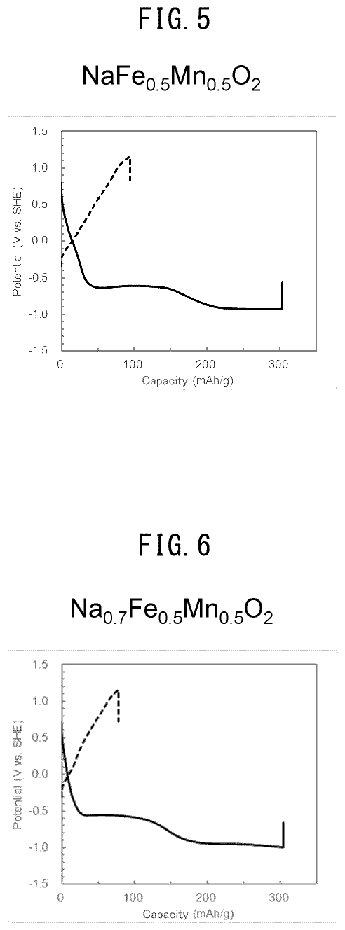

FIG. 5 shows a charge-discharge curve in the case of use of the active material according to Example 3. As shown in FIG. 5, charge and discharge in the aqueous electrolyte solution were possible with the active material according to Example 3. The reaction potential of the active material according to Example 3 was mainly a minus potential, and was found to be able to suitably function as, for example, the negative electrode active material.

### 5.4 Example 4: Na_{0.7}Fe_{0.5}Mn_{0.5}O₂

FIG. 6 shows a charge-discharge curve in the case of use of an active material according to Example 4. As shown in FIG. 6, charge and discharge in the aqueous electrolyte solution were possible with the active material according to Example 4. The reaction potential of the active material according to Example 4 was mainly a minus potential, and was found to be able to suitably function as, for example, the negative electrode active material.

### 5.5 Example 5: NaFe_{0.75}Ni_{0.25}O₂

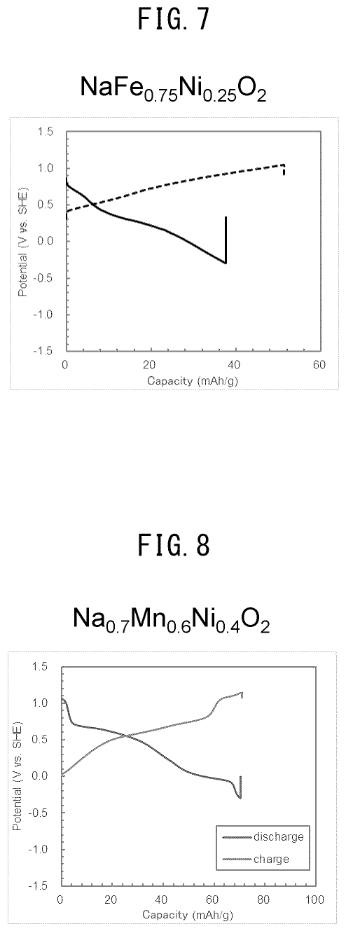

FIG. 7 shows a charge-discharge curve in the case of use of the active material according to Example 5. As shown in FIG. 7, charge and discharge in the aqueous electrolyte solution were possible with the active material according to Example 5. The reaction potential of the active material according to Example 5 was mainly a plus potential, and was found to be able to suitably function as, for example, the positive electrode active material.

### 5.6 Example 6: Na_{0.7}Mn_{0.6}Ni_{0.4}O₂

FIG. 8 shows a charge-discharge curve in the case of use of the active material according to Example 6. As shown in FIG. 8, charge and discharge in the aqueous electrolyte solution were possible with the active material according to Example 6. The reaction potential of the active material according to Example 6 was mainly a plus potential, and was found to be able to suitably function as, for example, the positive electrode active material.

### 5.7 Example 7: Na_{0.5}Mn_{0.75}Ni_{0.25}O₂

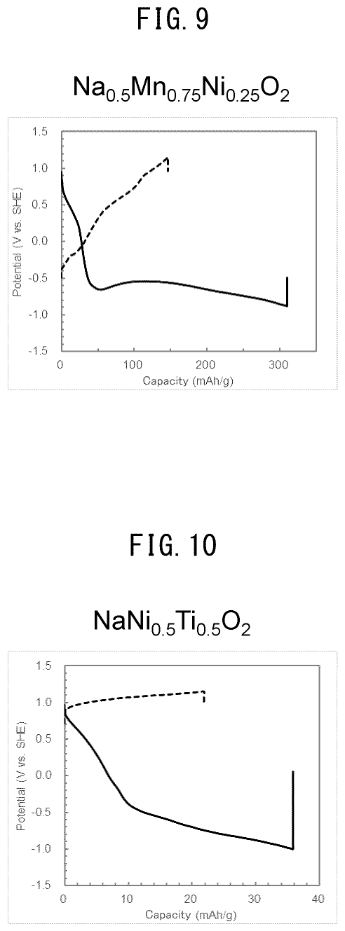

FIG. 9 shows a charge-discharge curve in the case of use of the active material according to Example 7. As shown in FIG. 9, charge and discharge in the aqueous electrolyte solution were possible with the active material according to Example 7. The active material according to Example 7 had respective reaction potentials on both the plus and minus potential sides, and was found to be able to function as, for example, both the positive electrode active material and the negative electrode active material.

### 5.8 Example 8: NaNi_{0.5}Ti_{0.5}O₂

FIG. 10 shows a charge-discharge curve in the case of use of the active material according to Example 8. As shown in FIG. 10, charge and discharge in the aqueous electrolyte solution were possible with the active material according to Example 8. The reaction potential of the active material according to Example 8 was mainly a plus potential, and was found to be able to suitably function as, for example, the positive electrode active material.

### 5.9 Example 9: NaFe_{0.5}Ni_{0.5}O₂

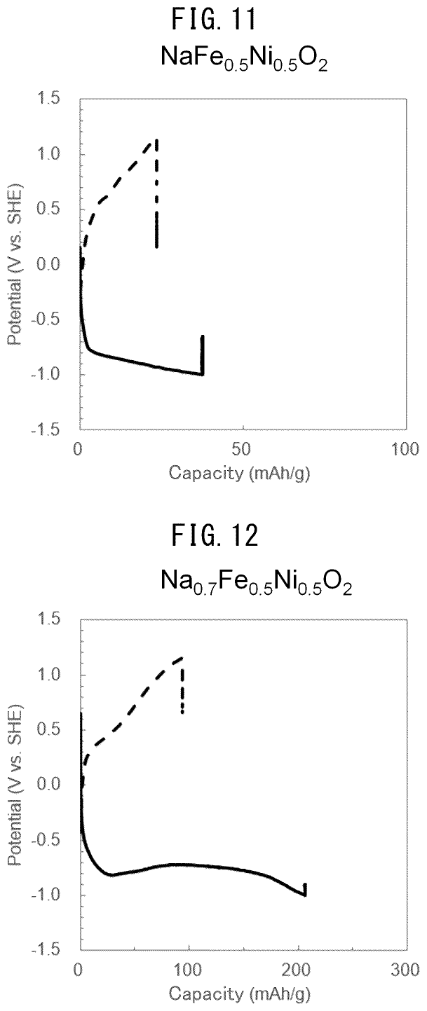

FIG. 11 shows a charge-discharge curve in the case of use of the active material according to Example 9. As shown in FIG. 11, charge and discharge in the aqueous electrolyte solution were possible with the active material according to Example 9. The active material according to Example 9 had respective reaction potentials on both the plus and minus potential sides, and was found to be able to function as, for example, both the positive electrode active material and the negative electrode active material.

### 5.10 Example 10: Na_{0.7}Fe_{0.5}Ni_{0.5}O₂

FIG. 12 shows a charge-discharge curve in the case of use of the active material according to Example 10. As shown in FIG. 12, charge and discharge in the aqueous electrolyte solution were possible with the active material according to Example 10. The active material according to Example 10 had respective reaction potentials on both the plus and minus potential sides, and was found to be able to function as, for example, both the positive electrode active material and the negative electrode active material.

### 5.11 Example 11: NaTi_{0.5}Mn_{0.5}O₂

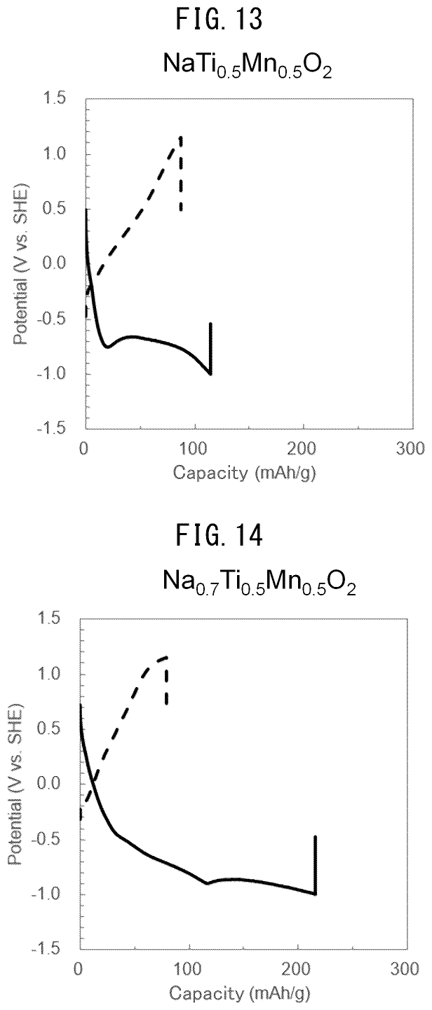

FIG. 13 shows a charge-discharge curve in the case of use of the active material according to Example 11. As shown in FIG. 13, charge and discharge in the aqueous electrolyte solution were possible with the active material according to Example 11. The active material according to Example 11 had respective reaction potentials on both the plus and minus potential sides, and was found to be able to function as, for example, both the positive electrode active material and the negative electrode active material.

### 5.12 Example 12: Na_{0.7}Ti_{0.5}Mn_{0.5}O₂

FIG. 14 shows a charge-discharge curve in the case of use of the active material according to Example 12. As shown in FIG. 14, charge and discharge in the aqueous electrolyte solution were possible with the active material according to Example 12. The active material according to Example 12 had respective reaction potentials on both the plus and minus potential sides, and was found to be able to function as, for example, both the positive electrode active material and the negative electrode active material.

### 5.13 Example 13: NaFe_{0.75}Ti_{0.25}O₂

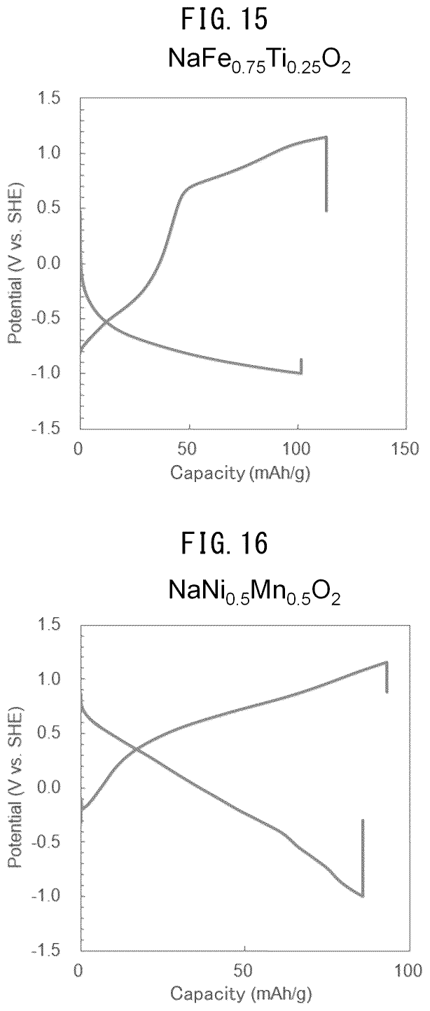

FIG. 15 shows a charge-discharge curve in the case of use of the active material according to Example 13. As shown in FIG. 15, charge and discharge in the aqueous electrolyte solution were possible with the active material according to Example 13. The reaction potential of the active material according to Example 13 was mainly a minus potential, and was found to be able to suitably function as, for example, the negative electrode active material.

### 5.14 Example 14: NaNi_{0.5}Mn_{0.5}O₂

FIG. 16 shows a charge-discharge curve in the case of use of the active material according to Example 14. As shown in FIG. 16, charge and discharge in the aqueous electrolyte solution were possible with the active material according to Example 14. The reaction potential of the active material according to Example 14 was mainly a plus potential, and was found to be able to suitably function as, for example, the positive electrode active material.

### 5.15 Example 15: NaFe_{0.25}Ni_{0.75}O₂

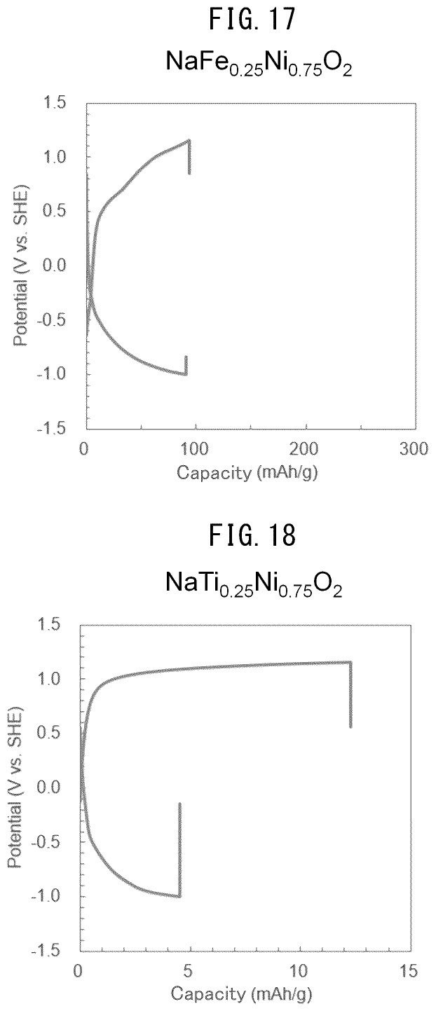

FIG. 17 shows a charge-discharge curve in the case of use of the active material according to Example 15. As shown in FIG. 17, charge and discharge in the aqueous electrolyte solution were possible with the active material according to Example 15. The active material according to Example 15 had respective reaction potentials on both the plus and minus potential sides, and was found to be able to function as, for example, both the positive electrode active material and the negative electrode active material.

### 5.16 Example 16: NaTi_{0.25}Ni_{0.75}O₂

FIG. 18 shows a charge-discharge curve in the case of use of the active material according to Example 16. As shown in FIG. 18, charge and discharge in the aqueous electrolyte solution were possible with the active material according to Example 16. The active material according to Example 16 had respective reaction potentials on both the plus and minus potential sides, and was found to be able to function as, for example, both the positive electrode active material and the negative electrode active material.

### 2.16 Example 17: NaMn_{0.25}Ni_{0.75}O₂

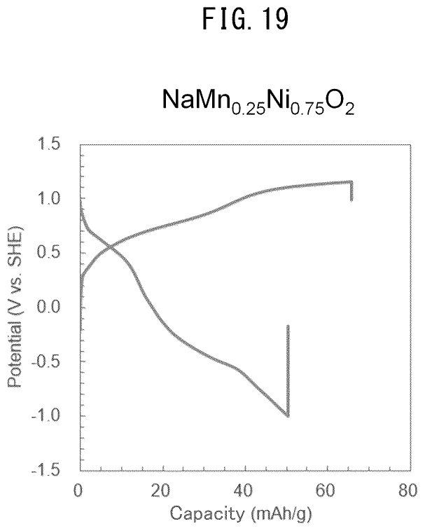

FIG. 19 shows a charge-discharge curve in the case of use of the active material according to Example 17. As shown in FIG. 19, charge and discharge in the aqueous electrolyte solution were possible with the active material according to Example 17. The reaction potential of the active material according to Example 17 was mainly a plus potential, and was found to be able to suitably function as, for example, the positive electrode active material.

### 6. Supplementation

A case where potassium pyrophosphate was dissolved as the potassium polyphosphate in the aqueous electrolyte solution was exemplified in Examples above. However, the potassium polyphosphate dissolved in the aqueous electrolyte solution is not limited to potassium pyrophosphate. The present inventor has confirmed that the same effects as described above are exerted even in a case where potassium polyphosphate (for example, potassium tripolyphosphate) other than potassium pyrophosphate is dissolved in the aqueous electrolyte solution, instead of potassium pyrophosphate or together with potassium pyrophosphate.

A case where an electrolyte other than potassium polyphosphate was not adopted in the aqueous electrolyte solution was also exemplified in Examples above. However, an electrolyte other than the potassium polyphosphate may be included in the aqueous electrolyte solution.

### 7. Conclusion

It can be said from the foregoing results that an aqueous battery including the following active material and aqueous electrolyte solution can be charged and discharged.

(1) One of or both the positive electrode active material and the negative electrode active material contain(s) a composite oxide. Herein, the composite oxide contains Na, at least one transition metal element of Fe, Ti, Ni and Mn, and O.

(2) The aqueous electrolyte solution contains water and potassium polyphosphate dissolved in the water.

### REFERENCE SIGNS LIST

10 positive electrode
   11 positive electrode active material layer
   12 positive electrode current collector
20 aqueous electrolyte solution
30 negative electrode
   31 negative electrode active material layer
   32 negative electrode current collector
40 separator
100 aqueous battery

1. An aqueous battery comprising a positive electrode, an aqueous electrolyte solution and a negative electrode, wherein
the positive electrode comprises a positive electrode active material,
the negative electrode comprises a negative electrode active material,
one of or both the positive electrode active material and the negative electrode active material comprise(s) a composite oxide,
the composite oxide comprises
Na,
at least one transition metal element of Fe, Ti, Ni and Mn, and O, and
the aqueous electrolyte solution comprises
water and
potassium polyphosphate dissolved in the water.

2. The aqueous battery according to claim 1, wherein
one of or both the positive electrode active material and the negative electrode active material comprise(s) at least one of a first composite oxide, a second composite oxide, and a third composite oxide,
the first composite oxide has a composition represented by NaₓFe_{1-y}M¹_{y}O₂,
the second composite oxide has a composition represented by NaₓTi_{1-y}M²_{y}O₂,
the third composite oxide has a composition represented by NaₓNi_{1-y}M³_{y}O₂,
wherein
0<x≤1 is satisfied,
0≤y≤1 is satisfied,
M¹ comprises one of or both Ti and Mn and does not comprise Ni,
M² comprises one of or both Fe and Mn and does not comprise Ni, and
M³ comprises at least one of Fe, Ti and Mn.

3. The aqueous battery according to claim 2, wherein
the negative electrode active material comprises one of or both the first composite oxide and the second composite oxide.

4. The aqueous battery according to claim 3, wherein
M¹ corresponds to one of or both Ti and Mn, and
M² corresponds to one of or both Fe and Mn.

5. The aqueous battery according to claim 2, wherein
the positive electrode active material comprises the third composite oxide.

6. The aqueous battery according to claim 5, wherein
M³ is at least one of Fe, Ti, and Mn.

7. The aqueous battery according to claim 1, wherein
the aqueous electrolyte solution comprises the potassium polyphosphate dissolved at a concentration of 3 mol or more per 1 kg of the water.

8. The aqueous battery according to claim 1, wherein
the aqueous electrolyte solution comprises the potassium polyphosphate dissolved at a concentration of 3 mol or more and 6 mol or less per 1 kg of the water.

9. The aqueous battery according to claim 1, wherein
the aqueous electrolyte solution comprises the potassium polyphosphate dissolved at a concentration of 4 mol or more and 6 mol or less per 1 kg of the water.

10. The aqueous battery according to claim 1, wherein
the aqueous electrolyte solution has no freezing point at −40° C. or higher.

11. The aqueous battery according to claim 1, wherein
the aqueous electrolyte solution does not involve salt precipitation when cooled from 0° C. to −40° C.

12. The aqueous battery according to claim 1, wherein
the aqueous electrolyte solution has a viscosity of 10 mPa·s or more and 600 mPa·s or less at 20° C.

13. The aqueous battery according to claim 1, wherein
a pH of the aqueous electrolyte solution is 3 or more and 13 or less.

14. The aqueous battery according to claim 1, wherein
one of or both the positive electrode and the negative electrode comprise(s) a current collector comprising Al.

15. The aqueous battery according to claim 14, wherein
the aqueous battery has a bipolar structure,
a positive electrode active material layer is formed on one side of the current collector, and
a negative electrode active material layer is formed on the other side of the current collector.
